(19) United States
(12) Patent Application Publication
(10) Pub. No.: US 2021/0256609 A1
(43) Pub. Date: Aug. 19, 2021

(54) ARBITRAGE PROTECTION SYSTEM AND METHOD TO DETERMINE BEST PRICE OF SECURITIES IN OTC MARKET

(71) Applicants: Anchal Jain, Tanjong Rhu (SG); SynOption Pte. Ltd., Shenton (SG)

(72) Inventor: Anchal Jain, Tanjong Rhu (SG)

(73) Assignee: SynOption Pte. Ltd., (SG)

(21) Appl. No.: 16/792,510

(22) Filed: Feb. 17, 2020

(51) Int. Cl. G06Q 40/06; G06Q 40/04; G06Q 30/08

(52) U.S. Cl. CPC G06Q 40/06; G06Q 30/08; G06Q 40/04

(57) ABSTRACT

An arbitrage protection system, a method, and a computer program product may be provided to determine best price of a security in an Over the Counter market. A system may include a memory configured to store computer program code and a processor configured to execute the computer program code to obtain price data associated with the security from systems, such as multi-dealer platforms. The price data may include one or more bid prices and one or more offer prices of the security. The processor may be configured to determine a best price of the security, based on the price data to minimize arbitrage. The best price may include a modified bid price and a modified offer price.

### TECHNOLOGICAL FIELD

The present disclosure generally relates to arbitrage protection system, and more particularly relates to determination of best price of securities for electronic trading in Over the Counter (OTC) markets.

### BACKGROUND

The OTC Markets are decentralized markets, where trades are executed between counterparties without the presence of a central location or an exchange. The trades executed in the OTC markets are typically bilateral trades, where agreement of price of a security may be reached between two counterparties.

In certain scenarios, the OTC markets may not trade in standard instruments. In certain other scenarios, it may become difficult for a liquid market to determine, monitor and transact on an exact price of the security at all times because of the complexity or the sheer volume of possible securities that can be traded. The OTC markets do not have a common place where the security is traded. Therefore, market participants trade on their determination of fair price of the security. The OTC markets have participants that are classified as Market makers or Liquidity Providers (LPs) who make bid/offer prices for any range of instruments at which they are ready to buy and sell such instruments. In many scenarios, there is no transparent traded liquid market for the instruments. Liquidity Takers (LTs) deal with the LPs by buying the security at their offer or selling the security at their bid. There is a flaw in liquidity access that market takers have, especially in illiquid OTC markets. In some execution modes in electronic trading, such as RFQ (Request for Quotation) and RFS (Request for Streaming) based streaming systems, there is a challenge faced by the LPs because of the presence of inverted prices or arbitrage when prices are aggregated with other LPs. An arbitrage opportunity is present for the LT, when there is the opportunity to instantaneously buy something for a low price and sell it for a higher price.

Accordingly, there is a need for a system to counteract latency driven arbitrage and also arbitrage due to lack of enough market information.

### BRIEF SUMMARY

Accordingly, there is a need for a reliable arbitrage protection system for electronic trading in securities for Over the Counter (OTC) market. A, system, a method, and a computer program product are provided herein that focuses on electronic trading in securities for Over the Counter (OTC) market to curb on the arbitrage problem, based on price data available from one or more LPs for one or more securities.

In one aspect, the system for determining a best price of at least one security may be provided. The system may include at least one non-transitory memory configured to store computer program code; and at least one processor (hereinafter referred as processor) configured to execute the computer program code to obtain price data associated with at least one security. The price data may include one or more bid prices and one or more offer prices of the at least one security. The processor may be configured to determine a best price of the at least one security, based on the price data to minimize arbitrage. The best price may include a modified bid price and a modified offer price.

According to some example embodiments, the price data may include one bid price and one offer price. The best price of the at least one security may be determined by the processor as: BP={(B1+O1)/2, (B1+O1)/2}. BP may indicate the best price of the at least one security. B1 may indicate the first best bid price from the price data for the at least one security. O1 may indicate the first best offer price from the price data for the at least one security, B1 may be greater than O1. (B1+O1)/2 may indicate the modified bid price of the best price of the at least one security. (B1+O1)/2 may indicate the modified offer price of the best price of the at least one security.

According to some example embodiments, the price data comprises at least two bid prices and one offer price, the best price of the at least one security is determined as: BP=maximum ((B1+O1)/2, B2). BP may indicate the best price of the at least one security. B1 may indicate first best bid price from the price data for the at least one security. O1 may indicate first best offer price from the price data for the at least one security. B2 may indicate second best bid price available from the price data for the at least one security. B1 may be greater than O1 and maximum ((B1+O1)/2, B2) may indicate the modified bid price and the modified offer price of the best price of the at least one security.

According to some example embodiments, the price data comprises one bid price and at least two offer prices, the best price of the at least one security may be determined as: BP=minimum ((B1+O1)/2, O2). BP may indicate the best price of the at least one security. B1 may indicate first best bid price available from the price data for the at least one security. O1 may indicate first best offer price available from the price data for the at least one security. O2 may indicate second best offer price available from the price data for the at least one security. B1 may be greater than O1 and minimum ((B1+O1)/2, B2) may indicate the modified bid price and the modified offer price of the best price of the at least one security.

According to some example embodiments, the price data may include at least two bid prices and at least two offer prices. The best price of the at least one security may be determined by the processor as BP=(B2, O2). BP may indicate the best price of the at least one security. B2 may indicate second best bid price from the price data for the at least one security. O2 may indicate second best offer price from the price data for the at least one security. B2 may be greater than O2. B2 may indicate the modified bid price of the best price of the at least one security. O2 may indicate the modified offer price of the best price of the at least one security.

The price data may include at least two bid prices and at least two offer prices. The at least two bid prices may include a first best bid price B1 and a second best bid price B2. The at least two offer prices may include a first best offer price O1 and a second best offer price O2, such that B1 may be greater than O1 and B2 may be less than O2. The processor may be configured to determine the best price of the at least one security by determining a first difference between B1 and B2. The processor may be configured to determine a second difference between O1 and O2. The processor may be configured to determine a third difference between B1 and O1. The processor may be configured to determine the best price of the at least one security based on the first difference, the second difference and the third difference.

According to some example embodiments, the best price may be determined by the processor as BP={B1−(BD*BOD)/(BD+OD), O1+(OD*BOD)/(BD+OD)}. BP indicates the best price of the at least one security. BD indicates the first difference between B1 and B2. OD indicates the second difference between O1 and O2. BOD indicates the third difference between B1 and O1. B1−(BD*BOD)/(BD+OD) indicates a modified bid of the best price, and O1+(OD*BOD)/(BD+OD) indicates a modified offer of the best price.

Embodiments disclosed herein may provide an arbitrage protection method for electronic trading in securities for Over the Counter (OTC) market may be provided. The arbitrage protection method may include obtaining, by one or more processors, price data associated with a price of at least one security. The price data may include one or more bid prices and one or more offer prices of the at least one security. The arbitrage protection method may include determining, by the processor, a best price of the at least one security, based on the price data to minimize arbitrage. The best price may comprise a modified bid price and a modified offer price, both are equal, thereby eliminating arbitrage

Embodiments of the present disclosure may provide a computer programmable product including at least one non-transitory computer-readable storage medium having computer-executable program code stored therein. The computer programmable product comprising a non-transitory computer readable medium having stored thereon computer executable instructions, which when executed by a computer, cause the computer to carry out operations, for generating traffic estimation data associated with at least one lane in a region, the operations comprising: obtaining, by one or more processors, price data associated with a price of at least one security. The price data comprises one or more bid prices and one or more offer prices of the at least one security; determining, by one or more processors, a best price of the at least one security, based on the price data to minimize arbitrage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a block diagram of the system, that may be used for arbitrage protection in electronic trading of securities for Over the Counter (OTC) market, in accordance with an example embodiment; and

FIG. 2 illustrates a flowchart for implementation of an exemplary method for arbitrage protection in electronic trading of securities for Over the Counter (OTC) market, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

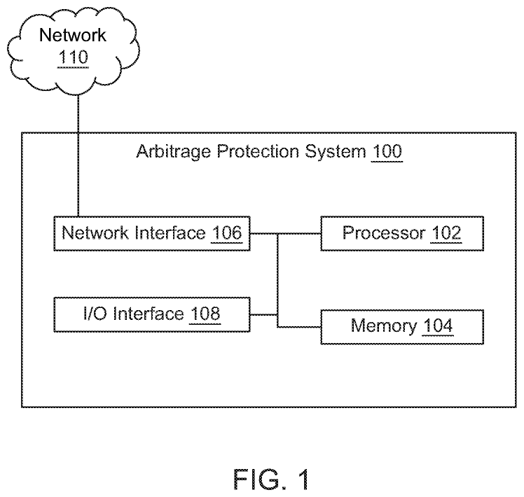

FIG. 1 illustrates a block diagram of the arbitrage protection system that may be used for arbitrage protection in electronic trading of securities for Over the Counter (OTC) market, in accordance with an example embodiment.

In the embodiments described herein, the arbitrage protection system 100 may include a processing means, such as, at least one processor (hereinafter interchangeably used with processor) 102, a storage means, such as, at least one memory (hereinafter interchangeably used with memory) 104, a communication means, such as, at least one network interface (hereinafter interchangeably used with network interface) 106 and an I/O interface 108. The arbitrage protection system 100 may communicate with other platforms, via a network 110. The processor 102 may retrieve computer program instructions that may be stored in the memory 104 for execution of the computer program instructions. The memory 104 may store price data of securities provided from systems, such as multi-dealer platform. The Multi Dealer Platform (MDP) is a platform where multiple LPs can provide prices. Such platforms are usually third-party platforms, that allow multiple LPs to provide prices, and an LT can see the aggregated price streams of multiple LPs. In accordance with an embodiment, the processor 102 may be configured to obtain input (such as, price data) from platforms, such as, the MDP and Single Dealer Platforms (SDP), and renders output, such as, the determination of a best price of the at least one security, based on the price data to minimize arbitrage. The best price may include a modified bid price and a modified offer price for use by a user on a user device through the network interface 106.

The processor 102 may be embodied in a number of different ways. For example, the processor 102 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 102 may include one or more processing cores configured to perform independently. A multi-core processor may enable multiprocessing within a single physical package. Additionally or alternatively, the processor 102 may include one or more processors configured in tandem via the bus to enable independent execution of instructions, pipelining and/or multithreading. Additionally or alternatively, the processor 102 may include one or more processors capable of processing large volumes of workloads and operations to provide support for big data analysis. In an example embodiment, the processor 102 may be in communication with the memory 104 via a bus for passing information among components of the arbitrage protection system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 102). The memory 104 may be configured to store information, data, content, applications, instructions, or the like, for enabling the arbitrage protection system 100 to carry out various functions in accordance with an example embodiment of the present disclosure. For example, the memory 104 may be configured to buffer input data for processing by the processor 102. As exemplarily illustrated in FIG. 1, the memory 104 may be configured to store instructions for execution by the processor 102. As such, whether configured by hardware or software methods, or by a combination thereof, the processor 102 may represent an entity (for example, physically embodied in circuitry) capable of performing operations according to an embodiment of the present disclosure while configured accordingly. Thus, for example, when the processor 102 is embodied as an ASIC, FPGA or the like, the processor 102 may be specifically configured hardware for conducting the operations described herein.

Alternatively, as another example, when the processor 102 is embodied as an executor of software instructions, the instructions may specifically configure the processor 102 to perform the algorithms and/or operations described herein when the instructions are executed. However, in some cases, the processor 102 may be a processor specific device (for example, a mobile terminal or a fixed computing device) configured to employ an embodiment of the present disclosure by further configuration of the processor 102 by instructions for performing the algorithms and/or operations described herein. The processor 102 may include, among other things, a clock, an arithmetic logic unit (ALU) and logic gates configured to support operation of the processor 102. The network environment may be accessed using the network interface 106 of the arbitrage protection system 100. The network interface 106 may provide an interface for accessing various features and data stored in the arbitrage protection system 100.

In some example embodiments, the I/O interface 108 may communicate with the arbitrage protection system 100 and displays input and/or output of the arbitrage protection system 100. As such, the I/O interface 108 may include a display and, in some embodiments, may also include a keyboard, a mouse, a joystick, a touch screen, touch areas, soft keys, one or more microphones, a plurality of speakers, or other input/output mechanisms. In one embodiment, the arbitrage protection system 100 may comprise user interface circuitry configured to control at least some functions of one or more I/O interface elements such as a display and, in some embodiments, a plurality of speakers, a ringer, one or more microphones and/or the like. The processor 102 and/or I/O interface 108 circuitry comprising the processor 102 may be configured to control one or more functions of one or more I/O interface 108 elements through computer program instructions (for example, software and/or firmware) stored on a memory 104 accessible to the processor 102. The processor 102 may further render best price notification on user equipment via the I/O interface 108.

The network 110 may comprise suitable logic, circuitry, and interfaces that may be configured to provide a plurality of network ports and a plurality of communication channels for transmission and reception of data, such as the price data. Each network port may correspond to a virtual address (or a physical machine address) for transmission and reception of the communication data. For example, the virtual address may be an Internet Protocol Version 4 (IPv4) (or an IPv6 address) and the physical address may be a Media Access Control (MAC) address. The network 110 may include a medium through which the arbitrage protection system 100, and/or the other components may communicate with each other. The network 110 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 110 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) network, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

In operation, a user may want to access (liquidity access) the OTC market for electronic trading in securities. The OTC markets are decentralized markets, where trades are executed between counterparties without the presence of a central location or an exchange. Recent years may have seen a huge advent of electronic trading in the OTC markets. The biggest market where such trading takes place is foreign exchange (FX) markets. The FX market, or currency market is a global decentralized or the OTC market for the trading of currencies that includes all aspects of buying, selling and exchanging currencies at current or determined prices. Electronic trading in securities provides various advantages. Firstly, the electronic trading provides ease of execution. Unlike voice traded systems, LTs can click-trade on prices to execute trades and have greater control in terms of executing at the price and time of their choice. An LT is a participant of the OTC market that is agreeing with currently listed prices on order book and wishes to fill his trade immediately.

Electronic trading also comes with advantages of Straight through Processing of trades directly into LP's and LT's risk management systems. The LPs include global banks, financial institutions and other market makers.

Secondly, the electronic trading provides increase in transparency. Aggregation of various electronic liquidity pools over a common platform lends transparency to an otherwise bilateral market by performing price discovery role that an exchange provides. However, due to the aggregation nature of this kind of operation, prices may be inverted. The prices may be inverted the bid of one user may be higher than the offer of another user.

There are different execution modes in electronic trading in the OTC markets, such as live streaming and RFQ/RFS based streaming. Most of FX markets operate on a “Live Streaming” basis, which means that the banks are continuously showing bid/offer prices for such securities. Due to the continuous nature of such markets, arbitrage opportunities usually get neutralized fairly quickly. RFQ/RFS based streaming: This is a popular method of electronic execution in markets where either the securities are illiquid, or where the sheer volume of possible securities that can be traded makes Live Streaming of all such securities impossible. A request for quotation (RFQ) is a standard business process whose purpose is to invite suppliers into a bidding process to bid on specific products or services. RFQ generally means the same thing as Call for bids (CFB) and Invitation for bid (IFB). However, the RFQ may involve both bid and offer. Further, the RFS may be a type of RFQ where an automated system at the LP end automatically starts streaming a bid and an offer for the instrument. A market in which that is difficult to sell assets because of their expense, lack of interested buyers, or some other reason is a market where the securities are illiquid. Examples of illiquid markets include real estate, some stocks with low trading volume, or collectibles.

Further, there may be Single Dealer Platform (SDP) and Multi Dealer Platform (MDP) in electronic trading of securities in the OTC markets. The SDP is a platform where only one LP provides prices. These are typically platforms that are proprietary to that particular LP and LTs use the platform to only trade with that LP. The MDP is a platform where multiple LPs can provide prices. The MDP platforms are usually third-party platforms that allow multiple LPs to provide prices, and an LT can see the aggregated price streams of multiple LPs.

The challenge faced in MDP platforms relate to the presence of “inverted prices” in RFQ based system. For example, an LT may request for a price associated with a security from 3 different LPs (viz., LP1, LP2, and LP3). The prices that the three LPs make are LP1 8.5/9.0, LP2 9.2/9.7, and LP3 8.8/9.3. For LPs, the format of the prices given is (Bid/Offer) and for the LT, the format of the prices given is (Sell/Buy). The LT who has requested for the price gets an inverted price on aggregation of the 3 prices: 9.2/9.0. In other words, the LT can sell the security at 9.2 and buy the security at 9.0. Effectively, the LT may execute both sides of the trade and make a profit of 0.2. This particular anomaly is known as Arbitrage. The simultaneous buying and selling of securities, currency, or commodities in different markets or in derivative forms in order to take advantage of differing prices for the same asset may be known as the arbitrage. In other words, an arbitrage opportunity is present when there is an opportunity to instantaneously buy something for a low price and sell it for a higher price. People who engage in arbitrage are called arbitrageurs. The term “arbitrage” may be mainly applied to trading in financial instruments, such as bonds, stocks, derivatives, commodities and currencies.

There are various reasons for Arbitrage. The two main reasons due to which arbitrage can occur are illiquid security with limited transparency and “Axed price” in illiquid markets. In illiquid security with limited transparency, there is a multitude of securities that do not trade daily, or for much longer periods of time. Due to the commitment of LPs to make markets, they will provide prices in such securities despite price transparency. As the perception of the LPs on true value of the security could be different, the prices that they make can lead to an arbitrage. In “Axed price” in illiquid markets, there are situations where the underlying market does not provide enough liquidity for an LP to exit a position by accessing the secondary market. In such a case, an LP might knowingly show a bid higher than the market offer or vice versa in order to accumulate a position that they can't otherwise get in the normal secondary market.

Arbitrage situations may only occur in the MDP electronic markets as compared to the SDP electronic markets because the MDP electronic markets may have multiple price makers. Such platforms may be run by third party participants and they usually address the arbitrage in one or more ways, such as, do nothing where the arbitrage price is shown to the LT and the LT is able to make risk free profit due to market illiquidity. Secondly, disable the outlier price where the platform disables the price that seems to be an outlier and hence cannot be traded. The issue with the second approach is that in very illiquid markets, it is difficult to determine with confidence which price is the outlier price. The other issue is in the case of Axed prices, where the LP knowingly wants to buy above market offer and gets disabled despite being the best bid. Further, add delay to prices to curb on arbitrage that occurs due to the latency of prices. Many anti-latency arbitrage mechanisms may be used to address the issue of latency arbitrage to reduce susceptibility by high frequency trading platforms.

The MDP electronic market that works over RFQ based trading in the OTC markets where there is no central price reference. Each LP may provide a price based on their inference of where the market should be and hence is subject to making various different prices that can be arbitraged. Generally, it may be assumed that the arbitrage occurs due to the latency of prices i.e. they occur as one price maker is slower in reacting to price changes in market as compared to others, giving a chance to quicker participants to gain from that. To counter it, anti-latency arbitrage mechanism may be used. However, the arbitrage protection system 100 may provide a solution that not only accounts to counteract latency driven arbitrage but also arbitrage due to lack of enough market information.

The arbitrage protection system 100 may work for the MDPs seeking to aggregate liquidity. In accordance with an embodiment, the arbitrage protection system 100 may be configured to work for RFQ/RFS based OTC system where liquidity is provided and price discovery happens on an ad-hoc basis leading to the LT seeing a variety of prices that could be arbitraged. The arbitrage protection system 100 may be configured to for streaming aggregation platforms to remove arbitrage even when prices associated with price data may be obtained continuously.

The arbitrage protection system 100 may be configured to obtain the price data associated with a price of at least one security from different LPs. The price data may include one or more bid prices and one or more offer prices of the at least one security. The arbitrage protection system 100 may account for the price data available to the platform based on the bid and offer stacks for a particular price, to modify the bid prices and offer prices in favor of the LPs to minimize situations of arbitrage. A bid price may be a price selected by a buyer to buy a stock, while the offer price may be a price at which a seller is offering to sell the stock.

The processor 102 of the arbitrage protection system 100 may be configured to determine a best price of the at least one security, based on the price data to minimize arbitrage. The best price may include a modified bid price and a modified offer price.

When there are a plurality of bid prices and a plurality of offer prices available from the price data, the plurality of bid prices may be arranged in decreasing order, such that the highest bid price (and hence first best bid price)) is B1. Similarly, the second highest bid price (and hence second best bid price) is B2. The plurality of offer prices may be arranged in increasing order, such that the lowest offer price (and hence first best offer price) is O1 and second lowest offer price (and hence second best offer price) is O2. If there is an addition which says that when the first best bid price from the price data is less than a first best offer price, no arbitrage protection may be required. Hence, the modified bid price may be equal to the first best bid price B1 and the modified offer price may be equal to second best bid price B2.

The processor 102 of the arbitrage protection system 100 may be configured to determine the best price of the at least one security when the price data comprises only one bid price and only one offer price. The best price of the at least one security may be determined as BP={(B1+O1)/2, (B1+O1)/2}. BP may indicate the best price of the at least one security. B1 may indicate the one bid price from the price data for the at least one security. O1 may indicate the one offer price from the price data for the at least one security, B1 may be greater than O1. (B1+O1)/2 may indicate the modified bid price of the best price of the at least one security. (B1+O1)/2 may indicate the modified offer price of the best price of the at least one security.

The processor 102 of the arbitrage protection system 100 may be configured to determine the best price of the at least one security when the price data comprises at least two bid prices and only one offer price. The best price of the at least one security may be determined as BP=maximum ((B1+O1)/2, B2). Therefore, both modified bid price and the modified offer price of the best price of the at least one security are maximum ((B1+O1)/2, B2). BP may indicate the best price of the at least one security. B1 may indicate first bid price (also referred as best bid price) from the price data for the at least one security. O1 may indicate first offer price from the price data for the at least one security. B2 may indicate second bid price (also referred as second best bid price) available from the price data for the at least one security.

The processor 102 of the arbitrage protection system 100 may be configured to determine the best price of the at least one security when the price data comprises only one bid price and at least two offer prices. The best price of the at least one security may be determined as BP=minimum ((B1+O1)/2, O2). Therefore, both modified bid price and the modified offer price of the best price of the at least one security are minimum ((B1+O1)/2, B2). BP may indicate the best price of the at least one security. B1 may indicate first bid price (also referred as first best bid price) available from the price data for the at least one security. O1 may indicate first offer price (also referred as first best offer price) available from the price data for the at least one security. O2 may indicate second offer price (also referred as second best offer price) available from the price data for the at least one security.

The processor 102 of the arbitrage protection system 100 may be configured to determine the best price of the at least one security when the price data comprises at least two bid prices and at least two offer prices. The best price of the at least one security may be determined by the processor as BP=(B2, O2). BP may indicate the best price of the at least one security. B2 may indicate second bid price (also referred as second best bid price) from the price data for the at least one security. O2 may indicate second offer price (also referred as second best offer price) from the price data for the at least one security. B2 may be greater than O2. B2 may indicate the modified bid price of the best price of the at least one security. O2 may indicate the modified offer price of the best price of the at least one security.

The processor 102 of the arbitrage protection system 100 may be configured to determine the best price of the at least one security when the price data comprises two bid prices and two offer prices. The two bid prices may include a first best bid price B1 and a second best bid price B2. The two offer prices may include a first best offer price O1 and a second best offer price O2, such that B1 may be greater than O1 and B2 may be less than O2. The processor may be configured to determine the best price of the at least one security by determining a first difference between B1 and B2. The processor may be configured to determine a second difference between O1 and O2. The processor may be configured to determine a third difference between B1 and O1. The processor may be configured to determine the best price of the at least one security based on the first difference, the second difference and the third difference.

According to some example embodiments, the best price may be determined by the processor as BP={B1−(BD*BOD)/(BD+OD), O1+(OD*BOD)/(BD+OD)}. BP indicates the best price of the at least one security. BD indicates the first difference between B1 and B2. OD indicates the second difference between O1 and O2. BOD indicates the third difference between B1 and O1. B1−(BD*BOD)/(BD+OD) indicates a modified bid of the best price, and O1+(OD*BOD)/(BD+OD) indicates a modified offer of the best price. In all embodiments, the bid belongs to a user with bid B1 and offer belongs to a user with offer O1.

The code snippet used by the arbitrage protection system 100 may be provided below:

SynoArbitrageProtectedSpread (B1 as best bid, B2 as second best bid, O1 as best offer, O2 as second best offer) as [ModifiedBid, ModifiedOffer]

### MB=ModifiedBid

### MO=Modified Offer

If B1<O1 then

### MB=B1

### MO=O1

Else if B2=null and O2< >null

### [MB,MO]=[min(O2, (B1+O1)/2), min (O2,(B1+O1)/2)]

Else if B2< >null and O2=null

### [MB,MO]=[max(B2, (B1+O1)/2), max (B2,(B1+O1)/2)]

Else if B2=null and O2=null

### [MB,MO]=[(B1+O1)/2, (B1+O1)/2]

Else if B2>O2 then

### MB=B2

### MO=O2

### Else

### BD=B1−B2

### OD=O2−O1

### BOD=B1−O1

If OD=BD=0 then

### MB=MO=(B1+O1)/2 Else

### ChangePct=BD/(BD+OD)

### MB=B1−ChangePct*BOD

### MO=O1+(1−ChangePct)*BOD

### Endif

### Endif

### Return [MB, MO]

End function

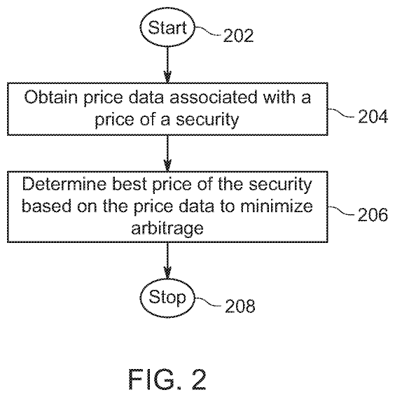

FIG. 2 illustrates a flowchart for implementation of an exemplary method for arbitrage protection in electronic trading of securities for Over the Counter (OTC) market, in accordance with an example embodiment. The control starts at 202.

At 204, price data associated with a price of at least one security may be obtained. The arbitrage protection system 100 may be configured to obtain the price data associated with a price of at least one security from different LPs. The price data may include one or more bid prices and one or more offer prices of the at least one security. The arbitrage protection system 100 may account for the price data available to the platform based on the bid and offer stacks for a particular price, to modify the bid prices and offer prices in favor of the LPs to minimize situations of arbitrage. A bid price may be a price selected by a buyer to buy a stock, while the offer price may be a price at which a seller is offering to sell the stock.

At 206, best price of the at least one security may be determined. The processor 102 of the arbitrage protection system 100 may be configured to determine a best price of the at least one security, based on the price data to minimize arbitrage. The best price may include a modified bid price and a modified offer price. Both, the modified bid price and a modified offer price of the best price may be equal to eliminate the arbitrage. The control passes to the end 208.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Alternatively, the system may comprise means for performing each of the operations described above. In this regard, according to an example embodiment, examples of means for performing operations may comprise, for example, the processor 102 and/or a device or circuit for executing instructions or executing an algorithm for processing information as described above.

On implementing the method disclosed herein, the end result generated by the arbitrage protection system 100 is a tangible determination of the best price of the at least one security in electronic trading from the price data. The determination of the best price of the at least one security is of utmost importance to avoid arbitrage.

Many modifications and other embodiments of the disclosures set forth herein will come to mind to one skilled in the art to which these disclosures pertain having the benefit of the teachings presented in the foregoing descriptions and the associated drawings. There may be modifications to the disclosed method with variation in bid prices and offer prices, such as, but not limited to, a second best bid price greater than a second best offer price, hence the disclosed method may be recursively applied in such a case. In accordance with an embodiment, the second best bid price and a third best bid price may be used instead of the first best bid price and the second best bid price, In accordance with an embodiment, the second best offer price and a third best offer price may be used instead of the first best offer price and the second best offer price. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

I claim:

1. An arbitrage protection system for electronic trading in securities for Over the Counter (OTC) market, comprising:
at least one non-transitory memory configured to store computer program instructions; and
at least one processor configured to execute the computer program instructions to:
obtain price data associated with a price of at least one security, wherein the price data comprises one or more bid prices and one or more offer prices of the at least one security; and
determine a best price of the at least one security, based on the price data to minimize arbitrage, wherein the best price comprises a modified bid price and a modified offer price.

2. The arbitrage protection system of claim 1, wherein the price data comprises at least two bid prices and at least two offer prices, wherein the two bid prices comprise a first best bid price B1 and a second best bid price B2, and wherein the at least two offer prices comprise a first best offer price O1 and a second best offer price O2, such that B1>O1 and B2<O2, to determine the best price of the at least one security, the at least one processor configured to:
determine a first difference between B1 and B2;
determine a second difference between O1 and O2;
determine a third difference between B1 and O1; and
determine the best price of the at least one security based on the first difference, the second difference and the third difference.

3. The arbitrage protection system of claim 2, wherein the best price is determined as
BP={B1−(BD*BOD)/(BD+OD),O1+(OD*BOD)/(BD+OD)},
wherein BP indicates the best price of the at least one security,
wherein BD indicates the first difference between B1 and B2,
wherein OD indicates the second difference between O1 and O2,
wherein BOD indicates the third difference between B1 and O1,
wherein B1−(BD*BOD)/(BD+OD) indicates a modified bid of the best price, and
wherein O1+(OD*BOD)/(BD+OD) indicates a modified offer of the best price.

4. The arbitrage protection system of claim 1, wherein the price data comprises one bid price and one offer price, the best price of the at least one security is determined as:
BP={(B1+O1)/2,(B1+O1)/2};
wherein BP indicates the best price of the at least one security,
wherein B1 indicates the first best bid price from the price data for the at least one security,
wherein O1 indicates the first best offer price from the price data for the at least one security,
wherein B1 is greater than O1,
wherein (B1+O1)/2 indicates the modified bid price of the best price of the at least one security, and
wherein (B1+O1)/2 indicates the modified offer price of the best price of the at least one security.

5. The arbitrage protection system of claim 1, wherein the price data comprises at least two bid prices and one offer price, the best price of the at least one security is determined as:
BP=maximum((B1+O1)/2,B2);
wherein BP indicates the best price of the at least one security,
wherein B1 indicates first best bid price from the price data for the at least one security,
wherein O1 indicates first best offer price from the price data for the at least one security,
wherein B2 indicates second best bid price available from the price data for the at least one security,
wherein B1 is greater than O1,
wherein maximum ((B1+O1)/2, B2) indicates the modified bid price and the modified offer price of the best price of the at least one security.

6. The arbitrage protection system of claim 1, wherein the price data comprises one bid price and at least two offer prices, the best price of the at least one security is determined as:
BP=minimum ((B1+O1)/2, O2);
wherein BP indicates the best price of the at least one security,
wherein B1 is greater than O1,
wherein B1 indicates first best bid price available from the price data for the at least one security,
wherein O1 indicates first best offer price available from the price data for the at least one security,
wherein O2 indicates second best offer price available from the price data for the at least one security,
wherein minimum ((B1+O1)/2, B2) indicates the modified bid price and the modified offer price of the best price of the at least one security.

7. The arbitrage protection system of claim 1, wherein the price data comprises at least two bid prices and at least two offer prices, the best price of the at least one security is determined as:
BP=(B2,O2);
wherein BP indicates the best price of the at least one security,
wherein B2 indicates second best bid price from the price data for the at least one security,
wherein O2 indicates second best offer price from the price data for the at least one security,
wherein B2 is greater than O2,
wherein B2 indicates the modified bid price of the best price of the at least one security, and
wherein O2 indicates the modified offer price of the best price of the at least one security.

8. An arbitrage protection method for electronic trading in securities for Over the Counter (OTC) market, comprising:
obtaining price data associated with a price of at least one security, wherein the price data comprises one or more bid prices and one or more offer prices of the at least one security; and
determining a best price of the at least one security, based on the price data to minimize arbitrage, wherein the best price comprises a modified bid price and a modified offer price.

9. The arbitrage protection method of claim 8, wherein the price data comprises at least two bid prices and at least two offer prices, wherein the two bid prices comprise a first best bid price B1 and a second best bid price B2, and wherein the two offer prices comprise a first best offer price O1 and a second best offer price O2, such that B1>O1 and B2<O2, to determine the best price of the at least one security, the at least one processor configured to:
determine a first difference between B1 and B2;
determine a second difference between O1 and O2;
determine a third difference between B1 and O1; and
determine the best price of the at least one security based on the first difference, the second difference and the third difference.

10. The arbitrage protection method of claim 9, wherein the best price is determined as
BP={B1−(BD*BOD)/(BD+OD),O1+(OD*BOD)/(BD+OD)},
wherein BP indicates the best price of the at least one security,
wherein BD indicates the first difference between B1 and B2,
wherein OD indicates the second difference between O1 and O2,
wherein BOD indicates the third difference between B1 and O1,
wherein B1−(BD*BOD)/(BD+OD) indicates a modified bid of the best price, and
wherein O1+(OD*BOD)/(BD+OD) indicates a modified offer of the best price.

11. The arbitrage protection method of claim 8, wherein the price data comprises one bid price and one offer price, the best price of the at least one security is determined as:
BP={(B1+O1)/2,(B1+O1)/2};
wherein BP indicates the best price of the at least one security,
wherein B1 indicates the first best bid price from the price data for the at least one security,
wherein O1 indicates the first best offer price from the price data for the at least one security,
wherein B1 is greater than O1,
wherein (B1+O1)/2 indicates the modified bid price of the best price of the at least one security, and
wherein (B1+O1)/2 indicates the modified offer price of the best price of the at least one security.

12. The arbitrage protection method of claim 8, wherein the price data comprises at least two bid prices and one offer price, the best price of the at least one security is determined as:
BP=maximum((B1+O1)/2,B2);
wherein BP indicates the best price of the at least one security,
wherein B1 indicates first best bid price from the price data for the at least one security,
wherein O1 indicates first best offer price from the price data for the at least one security,
wherein B2 indicates second best bid price available from the price data for the at least one security,
wherein B1 is greater than O1,
wherein maximum ((B1+O1)/2, B2) indicates the modified bid price and the modified offer price of the best price of the at least one security.

13. The arbitrage protection method of claim 8, wherein the price data comprises one bid price and at least two offer prices, the best price of the at least one security is determined as:
BP=minimum((B1+O1)/2,O2);
wherein BP indicates the best price of the at least one security,
wherein B1 indicates first best bid price available from the price data for the at least one security,
wherein O1 indicates first best offer price available from the price data for the at least one security,
wherein O2 indicates second best offer price available from the price data for the at least one security,
wherein B1 is greater than O1,
wherein minimum ((B1+O1)/2, B2) indicates the modified bid price and the modified offer price of the best price of the at least one security.

14. The arbitrage protection method of claim 8, wherein the price data comprises at least two bid prices and at least two offer prices, the best price of the at least one security is determined as:
BP=(B2,O2);
wherein BP indicates the best price of the at least one security,
wherein B2 indicates second best bid price from the price data for the at least one security,
wherein O2 indicates second best offer price from the price data for the at least one security,
wherein B2 is greater than O2,
wherein B2 indicates the modified bid price of the best price of the at least one security, and
wherein O2 indicates the modified offer price of the best price of the at least one security.

15. A computer programmable product comprising a non-transitory computer readable medium having stored thereon computer executable instructions, which when executed by one or more processors, cause the one or more processors to carry out operations for determining best price of at least one security in electronic trading, the operations comprising:
obtaining price data associated with a price of at least one security, wherein the price data comprises one or more bid prices and one or more offer prices of the at least one security; and
determining a best price of the at least one security, based on the price data to minimize arbitrage, wherein the best price comprises a modified bid price and a modified offer price.

16. The computer program product of claim 15, wherein the price data comprises at least two bid prices and at least two offer prices, wherein the two bid prices comprise a first best bid price B1 and a second best bid price B2, and wherein the two offer prices comprise a first best offer price O1 and a second best offer price 2, such that B1>O1 and B2<O2, wherein the operation of determining the best price of the at least one security further comprises:
determining a first difference between B1 and B2;
determining a second difference between O1 and O2;
determining a third difference between B1 and O1; and
determining the best price of the at least one security based on the first difference, the second difference and the third difference.

17. The computer program product of claim 16, wherein the best price is determined as
BP={B1−(BD*BOD)/(BD+OD),O1+(OD*BOD)/(BD+OD)},
wherein BP indicates the best price of the at least one security,
wherein BD indicates the first difference between B1 and B2,
wherein OD indicates the second difference between O1 and O2,
wherein BOD indicates the third difference between B1 and O1,
wherein B1−(BD*BOD)/(BD+OD) indicates a modified bid of the best price, and
wherein O1+(OD*BOD)/(BD+OD) indicates a modified offer of the best price.

18. The computer program product of claim 15, wherein the price data comprises one bid price and one offer price, the best price of the at least one security is determined as:
BP={(B1+O1)/2,(B1+O1)/2};
wherein BP indicates the best price of the at least one security,
wherein B1 indicates the first best bid price from the price data for the at least one security,
wherein O1 indicates the first best offer price from the price data for the at least one security,
wherein B1 is greater than O1,
wherein (B1+O1)/2 indicates the modified bid price of the best price of the at least one security, and
wherein (B1+O1)/2 indicates the modified offer price of the best price of the at least one security.

19. The computer program product of claim 15, wherein the price data comprises at least two bid prices and at least one offer price, the best price of the at least one security is determined as:
BP=maximum((B1+O1)/2,B2);
wherein BP indicates the best price of the at least one security,
wherein B1 indicates first best bid price from the price data for the at least one security,
wherein O1 indicates first best offer price from the price data for the at least one security,
wherein B2 indicates second best bid price available from the price data for the at least one security,
wherein B1 is greater than O1,
wherein maximum ((B1+O1)/2, B2) indicates the modified bid price and the modified offer price of the best price of the at least one security.

20. The computer program product of claim 15, wherein the price data comprises one bid price and at least two offer prices, the best price of the at least one security is determined as:
BP=minimum((B1+O1)/2,O2);
wherein BP indicates the best price of the at least one security,
wherein B1 indicates first best bid price available from the price data for the at least one security,
wherein O1 indicates first best offer price available from the price data for the at least one security,
wherein O2 indicates second best offer price available from the price data for the at least one security,
wherein B1 is greater than O1,
wherein minimum ((B1+O1)/2, B2) indicates the modified bid price and the modified offer price of the best price of the at least one security.
